(19) United States
(12) Patent Application Publication
(10) Pub. No.: US 2012/0121244 A1
(43) Pub. Date: May 17, 2012

(54) VARIABLE FOCUS ILLUMINATOR

(75) Inventor: Donald J. Stavely, Windsor, CO (US)

(73) Assignee: Congruent Concepts, LLC, Windsor, CO (US)

(21) Appl. No.: 13/294,026

(22) Filed: Nov. 10, 2011

Related U.S. Application Data
(60) Provisional application No. 61/456,891, filed on Nov. 15, 2010.

(51) Int. Cl. G03B 15/03; G02B 7/02; H05B 37/02; F21V 5/00

(52) U.S. Cl. 396/175; 362/232; 359/811; 315/294

(57) ABSTRACT

A variable focus illuminator includes an array of light sources and a movable lens plate positioned immediately in front of the array of light sources. The lens plate includes a plurality of lenses that redirect the light produced by the light sources, such that different positions of the lens plate result in different sizes of the field illuminated by the variable focus illuminator. The lens plate may be movable in translation, rotation, or both. The variable focus illuminator may also include a cover plate in front of the movable lens plate, which may also include a plurality of cover plate lenses. The variable focus illuminator may be varifocal, or may include a zoom capability. The variable focus illuminator may be part of a system that includes a camera, and the system may also include a pan/tilt mechanism.

This application claims priority from U.S. Provisional Patent Application No. 61/456,891 filed Nov. 15, 2010 and titled “Variable Focus Illuminator”, the entire disclosure of which is hereby incorporated by reference herein.

### BACKGROUND OF THE INVENTION

Illuminators are used in conjunction with video security cameras where and when the available light is insufficient for quality observation or recording of the subject scene. Examples of situations that would benefit from the use of an illuminator are unlit or partially lit parking lots, storage facilities, warehouses, office spaces, manufacturing facilities, and the like. These areas of interest for video observation include both indoor and outdoor spaces. For outdoor use, the security camera and the illuminator may be designed to be rugged and weatherproof.

Illuminators used in video security applications may provide visible light, infrared (IR) light, or both. The electronic sensors used in modern video cameras are intrinsically sensitive to both visible light and infrared light. When ambient light (sunlight or artificial light) is available and abundant, video cameras typically employ an infrared blocking filter that prevents infrared light collected by the camera's lens from reaching the sensor. Reducing or eliminating the infrared light allows for more accurate color rendition in the video image. When there is not sufficient ambient light for good color imaging, it is advantageous to remove the infrared blocking filter so that both infrared and visible light reach the sensor. The resulting image may not be as color-accurate as an image taken using only visible light, but the greater amount of available light makes it possible to produce an image higher quality in other respects, for example an image with less noise.

These video cameras with so-called “day-night” capability greatly extend the range of conditions in which usable video images can be obtained. Still, there are many locations and situations where the available light is not sufficient. These installations benefit from the use of illuminators to augment the available light. The advantage if IR illuminators is that the illuminator adds light that is visible to the camera, but invisible (or nearly invisible) to humans. This may be advantageous for several reasons. For example, some installations are designed to be covert. That is, in these installations, it is not desirable that subjects in the field of the video camera are aware that they are being observed or recorded. Some regions or municipalities also limit the amount of visible artificial light that is used at night. The goal of such “Dark Sky” initiatives is to reduce light pollution so that people can enjoy the night sky. Other reasons for using infrared illuminators are simply the annoyance, distraction, and ergonomic factors associated with the use of additional visible light.

The range of wavelengths typically used for IR illuminators in conjunction with day/night cameras is referred to as “near infrared”. Two common wavelengths of light produced by IR illuminators are 850 and 940 nm, although other wavelengths or ranges of wavelengths could be used. Illuminators producing light at a wavelength of 850 nm are commonly used because video sensors are reasonably sensitive at this wavelength. The human eye is weakly sensitive at 850 nm, so the illuminator is not truly covert—it will be seen to glow a deep red color. Illuminators producing light at a wavelength of 940 nm are used for covert illumination, since the eye is insensitive at this wavelength. The primary disadvantage of 940 nm is that the sensitivity of typical visible light sensors is significantly lower at this wavelength.

Different security cameras may have different fields of view, and some security cameras include zoom lenses such that the field of view of the camera is variable. There is accordingly a need for improved illuminators useful with cameras of differing or variable fields of view.

### BRIEF SUMMARY OF THE INVENTION

Embodiments of the invention provide illuminators whose field of illumination can be adjusted, for example to match the fields of cameras used in conjunction with the illuminators.

According to one aspect, a variable focus illuminator includes a plurality of light sources arranged in an array, and a lens plate positioned immediately in front of the array of light sources. The lens plate includes a plurality of lenses that redirect the light produced by the light sources. The relative positions of the lens plate and the light sources are changeable such that different relative positions of the lens plate and light sources result in different sizes of the field illuminated by the light sources. In some embodiments, the lens plate is movable to change the distance between the lens plate and the light sources. The lens plate may be rotatable about a rotation axis that is substantially parallel to the optical axis of the variable focus illuminator. In some embodiments, rotation of the lens plate causes beams emanating from at least some of the lenses to be skewed with respect to an optical axis of the variable focus illuminator. The variable focus illuminator may further comprise a locking mechanism to fix the lens plate in a particular position in relation to the light sources. In some embodiments, the variable focus illuminator further comprises an actuator configured to move the lens plate. The actuator may include a motor coupled to the lens plate, wherein the lens plate moves in reaction to rotation of a shaft of the motor. The actuator may be configured to change the distance between the lens plate and the light sources. The actuator may be configured to rotate the lens plate about a rotation axis substantially parallel to the optical axis of the variable focus illuminator. The actuator may be configured to simultaneously vary the rotational angle of the lens plate and the distance between the lens plate and the light sources. In some embodiments, the actuator further comprises a plurality of guide pins protruding radially from the lens plate, and a plurality of angled grooves in which the pins ride to tie the rotational angle of the lens plate to the distance between the lens plate and the light sources.

In some embodiments, the variable focus illuminator further includes a motor having a shaft, a gear driven by the motor, and gear teeth molded into a peripheral edge of the lens plate and configured to mate with the teeth of the gear, such that the lens plate is moved by rotation of the motor shaft. The lens plate may be a monolithic structure, with the plurality of lenses being formed by variations in the thickness of the monolithic structure. Each of the plurality of lenses may be a positive lens. Each of the plurality of lenses may be a negative lens. In some embodiments, the variable focus illuminator further includes a cover plate in front of the movable lens plate and fixed in relation to the light sources. The cover plate may further include a plurality of cover plate lenses, wherein the cover plate lenses are formed by variations in the thickness of the cover plate. The variable focus illuminator may further include an enclosure, wherein the cover plate forms a front face of the enclosure. In some embodiments, each of the lens plate lenses is a positive lens, and each of the cover plate lenses is a negative lens. The cover plate may include exactly one cover plate lens for each of the light sources. The plurality of light sources may include one or more light emitting diodes. The light sources may emit infrared light. The light sources may emit visible light. In some embodiments, the variable focus illuminator further includes a printed circuit board on which the plurality of light sources are mounted. The lens plate may include exactly one lens for each light source.

In some embodiments, the variable focus illuminator further includes a controller configured to control the position of the lens plate to vary the size of the field illuminated by the light sources. The controller may include a communication interface through which control commands are received from a remote control center. The controller may be configured to return status information about the variable focus illuminator to the remote control center via the communication interface. In some embodiments, the controller stores one or more preset combinations of settings for the variable focus illuminator, each preset combination being recalled in response to a single control command. The controller may be configured to change the amount of power being delivered to the light sources in response to a control command received via the communication interface. The controller may be configured to change the size of the field illuminated by the light sources in response to a control command received via the communication interface. In some embodiments, the controller is configured to change both the amount of power being delivered to the light sources and the size of the field illuminated by the light sources in response to a single control command received via the communication interface.

According to another aspect, a system includes a camera and a variable focus illuminator. The variable focus illuminator further includes a plurality of light sources arranged in an array and a lens plate positioned immediately in front of the array of light sources, the lens plate comprising a plurality of lenses that redirect the light produced by the light sources. The relative positions of the lens plate and the light sources are changeable such that different relative positions of the lens plate and light sources result in different sizes of the field illuminated by the light sources. In some embodiments, the camera includes a zoom lens, and the variable focus illuminator includes a motorized actuator configured to change the relative positions of the lens plate and the light sources to adjust the size of the field illuminated by the variable focus illuminator. The system may further include a communications interface through which control information is received.

In some embodiments, the system further includes a controller that automatically adjusts relative positions of the lens plate and the light sources of the variable focus illuminator such that the size of the field illuminated by the variable focus illuminator is increased when the camera field of view increases in size, and the size of the field illuminated by the variable focus illuminator is decreased when the camera field of view decreases in size. The controller may receive signals via a communications interface, the signals indicating a zoom setting for the camera, and the controller may derive a zoom setting for the variable focus illuminator from the camera zoom setting. The controller may derive the camera zoom setting by detecting control signals directed to the camera. The system may further include a pan/tilt mechanism to which both the camera and the variable focus illuminator are attached. In some embodiments, the system further includes a controller configured to automatically point and zoom the camera at a target of interest, and to change the size of the field illuminated by the variable focus illuminator to substantially match the field of view of the camera at the selected zoom setting. The actuator may be configured to move the lens plate. In some embodiments, the system further includes a communications interface for exchanging information with a remote monitoring center and a controller, and the controller is configured to send status information about the variable focus illuminator to the remote monitoring center via the communications interface. The system may further include a controller configured to adjust a level of power provided to the light sources.

According to another aspect, a method of adjusting an illumination field emitted by a variable focus illuminator includes emitting light from a plurality of light sources arranged in an array, and changing the relative positions of the array of light sources and a lens plate disposed immediately in front of the array of light sources. The lens plate includes a plurality of lenses configured to redirect light received from the plurality of light sources, and the size of the field illuminated by the light sources varies as a result of the change in the relative positions of the array of light sources and the lens plate. Changing the relative positions of the array of light sources and the lens plate may include moving the lens plate. Changing the relative positions of the array of light sources and the lens plate may include changing the distance between the lens plate and the plurality of light sources. Changing the relative positions of the array of light sources and the lens plate may include changing a rotational alignment of the lens plate and the array of light sources with respect to an optical axis of the variable focus illuminator. Changing the rotational alignment of the lens plate and the array of light sources with respect to the optical axis of the variable focus illuminator may cause beams emanating from at least some of the lenses to be skewed with respect to the optical axis of the variable focus illuminator. Changing the relative positions of the array of light sources and the lens plate may include both changing the distance between the lens plate and the plurality of light sources and changing a rotational alignment of the lens plate and the array of light sources with respect to an optical axis of the variable focus illuminator. In some embodiments, the method further includes disposing a fixed cover plate in front of the movable lens plate, the fixed cover plate being in a fixed position in relation to the plurality of light sources. In some embodiments, the method further includes, after moving the lens plate to alter the size of the field illuminated by the light sources, fixing the lens plate in place in relation to the light sources.

According to another aspect, a lens plate includes a plurality of lenses arranged in an array across the lens plate, and gear teeth formed in a peripheral edge of the lens plate. The lens plate may be monolithic and the plurality of lenses formed by variations in the thickness of the lens plate. At least one of the lenses in the lens plate may include a Fresnel step.

According to another aspect, a variable focus illuminator includes at least one light source, an optical system that is adjustable to change the size of the field illuminated by the at least one light source, a controller, a communication interface through which the controller receives control commands from a remote control center. The controller is configured to control the operation of the variable focus illuminator in response to control commands received via the communication interface. In some embodiments, the controller is configured to adjust the optical system to change the size of the field illuminated by the at least one light source in response to a control command received via the communications interface. In some embodiments, the controller is further configured to adjust the amount of power delivered to the at least one light source in response to a control command received via the communication interface. In some embodiments, the controller stores at least one preset combination of settings for the variable focus illuminator, and the controller is configured to recall one of the preset combinations in response to a control command received via the communication interface and to adjust the variable focus illuminator to conform to the recalled preset combination of settings. In some embodiments, the variable focus illuminator comprises a plurality of light sources arranged in an array, the optical system comprises a lens plate positioned immediately in front of the array of light sources, the lens plate comprising a plurality of lenses that redirect the light produced by the light sources, and the relative positions of the lens plate and the light sources are changeable such that different relative positions of the lens plate and light sources result in different sizes of the field illuminated by the light sources. The controller may be configured to receive at least one control command from the remote control center by detecting a control command directed to a device other than the variable focus illuminator. The controller may be configured to provide status information about the variable focus illuminator to the remote control center via the communication interface.

### BRIEF DESCRIPTION OF THE DRAWINGS

FIG. 1A illustrates an example light emitting diode (LED) in a leaded package.

FIG. 1B illustrates the intensity of light produced by the LED of FIG. 1A as a function of angle from the optical axis of the LED.

FIG. 2A illustrates another example LED.

FIG. 2B illustrates the intensity of light produced by the LED of FIG. 2A as a function of angle from optical axis of the LED.

FIG. 3A illustrates a particular type of prior art concentrator.

FIG. 3B illustrates the intensity of light produced by the concentrator of FIG. 3A as a function of angle from the optical axis of the concentrator.

FIG. 4A illustrates the concentrator of FIG. 3A with a diffuser attached.

FIG. 4B illustrates the intensity of light produced by the arrangement of FIG. 4A as a function of angle from the optical axis.

FIGS. 5A-5D illustrate the use of a simple positive refractive lens to vary the illumination field of an LED, in accordance with embodiments of the invention.

FIGS. 6A-6D illustrate the use of a simple negative refractive lens to vary the illumination field of an LED, in accordance with embodiments of the invention.

FIGS. 7A-7D illustrate a use of multiple lens elements to vary the illumination field of an LED, in accordance with embodiments of the invention.

FIGS. 8A-8C illustrate an arrangement similar to that of FIG. 5A, but with an additional degree of freedom that may improve the wide angle performance an illuminator, in accordance with embodiments of the invention.

FIGS. 9A-9C illustrate an arrangement similar to that of FIG. 7A, with an additional degree of freedom similar that that shown in FIG. 8C, that may improve the wide angle performance an illuminator, in accordance with embodiments of the invention.

FIGS. 10A and 10B illustrate an illuminator according to an embodiment of the invention.

FIG. 10C illustrates a cross section of an example individual lens, in accordance with embodiments.

FIGS. 11A and 11B illustrate an illuminator according to an embodiment of the invention.

FIGS. 12A-12D illustrate orthogonal views of an illuminator in accordance with another embodiment.

FIGS. 13A and 13B are oblique views of the illuminator of FIGS. 12A-12D.

FIGS. 14A and 14B illustrate an illuminator according to another embodiment of the invention.

FIG. 15 illustrates an example actuator usable in embodiments of the invention.

FIG. 16 illustrates a system in accordance with another embodiment of the invention.

### DETAILED DESCRIPTION OF THE INVENTION

Two common types of video security camera configurations are “fixed” cameras and “pan/tilt/zoom” (PTZ) cameras. Fixed cameras are used to observe or record images of a single fixed field of view. They are aimed during the installation process and typically not changed over their operating life. Since the camera lenses used in fixed applications need only cover a fixed field of view, they need only be designed for a fixed focal length. However, it is often not known at setup time exactly what lens focal length will be required for a particular installation. It is very inconvenient for the installer to have to stock and transport an array of lenses of incrementing focal lengths to cover all of the possible values that might be needed for any particular installation. For this reason, cameras designed for fixed applications typically use “varifocal” lenses. These lenses can be manually adjusted over a range of focal lengths. The camera can be aimed, be set in magnification or field of view, and focused at installation time, without detailed prior knowledge of the application or installation site. Only one or two varifocal lenses are needed to cover a very wide range of possible focal lengths.

A PTZ camera includes a motorized zoom lens, mounted on a motorized pan/tilt mechanism. The field of view of the camera, including both the direction of aim and the magnification of the video image, may be controllable remotely and in real-time. PTZ cameras are often controlled by an operator who can, for example, monitor a wide angle scene under normal conditions, and then re-aim the camera and zoom in on some object or activity of interest. Alternatively, the PTZ camera can be automatically controlled. For example, it could be panned slowly to cover a wide area at moderate magnification, or it could be programmed to move and zoom in on a series of areas of interest, such as entrances and exits to a building, parking lot, etc.

Thus, both fixed camera and PTZ cameras may use lenses with variable focal length—either varifocal or motorized zoom. However, many existing IR illuminators have fixed illumination patterns. Illuminators are typically offered with angles of illumination in steps of 10, 20, 30, 45, and 60 degrees, for example. For a particular physical size, power input, and total light power output, the intensity of the light falling on any point within the area of illumination will be inversely proportional to area of coverage. In other words, the illuminator is designed to concentrate its light output into a narrow angle, or to spread it over a wide angle. It is therefore advantageous to match the field of illumination of an illuminator with the field of view of a camera used in conjunction with the illuminator. For example, if the illumination field is narrower than the camera's field of view, only the center part of the field of view will be lit, and the surrounding part of the image will be dark. On the other hand, if the illumination angle is wider than the camera coverage, light will be wasted illuminating areas unseen by the camera, and the area seen by the camera will not receive as much light.

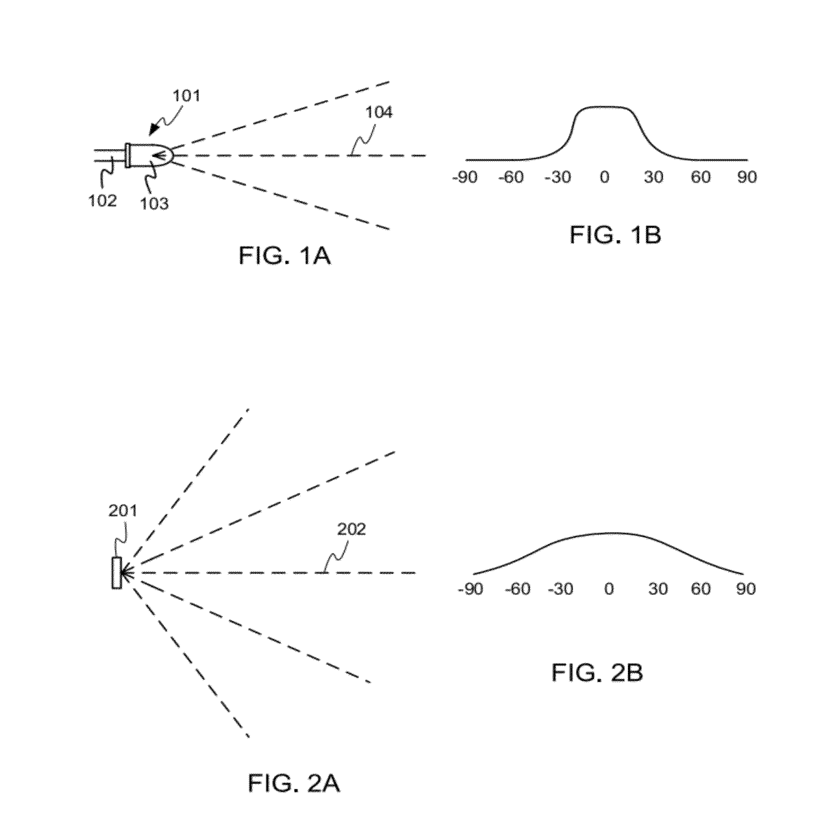

FIGS. 1A-9C illustrate certain components and optical principles usable in illuminators according to embodiments of the invention.

FIG. 1A illustrates an example light emitting diode (LED) 101 in a leaded package. Leads 102 are designed for mounting LED 101 onto a circuit board. LEDs may be especially useful as light sources in embodiments of the invention due to their high reliability and very efficient production of light in relation to the electrical power they consume, but it will be recognized that illuminators according to embodiments of the invention may use other kinds of light sources. For example, embodiments of the invention may use light sources that emit visible light and/or infrared light. Light sources other than LEDs may be used, and light sources of multiple types may be used. LED 101 also includes an integral molded plastic lens 103, that is designed to substantially direct light produced by LED 101 into a fixed illumination field around an optical axis 104. FIG. 1B illustrates the intensity of light produced by LED 101 as a function of angle from optical axis 104. In this example, the intensity drops dramatically beyond an angle of about 22.5 degrees from axis 104, and LED 101 may be said to have an illumination angle of about 45 degrees. Other LEDs of this type may have other viewing angles, for example 15, 30, or 60 degrees or another angle, depending on the particular designs of their integral lenses.

FIG. 2A illustrates another example LED 201. LED 201 does not have an integral molded lens, and does not include a leaded package, but is instead designed for surface mounting to a circuit board. As shown in FIG. 2B, the illumination field of LED 201 is broader and less sharply defined than the illumination field of LED 101. For example, the intensity of illumination may be approximately Lambertian, such that the intensity of LED 201 as observed from a particular viewing angle relative to optical axis 202 is approximately proportional to the cosine of the viewing angle, although other intensity distributions may be possible.

Other types of LEDs are also available and usable in embodiments of the invention, for example surface mountable LEDs that also include integral lenses. Preferably, the LEDs and other illuminator components are designed for high power operation. For example, each LED may have a thermal stud (not shown) under the die in addition to or integrated with its leads for making good thermal contact with a circuit board on which the LED is mounted. In some embodiments, a metal-core circuit board may be used, having an inner layer made of a thermally conductive material such as copper or aluminum for conducting heat away from the LEDs. The metal-core board may in turn be mounted in thermal contact with a heat sink, or to an enclosure having heat dissipating fins or other means of cooling.

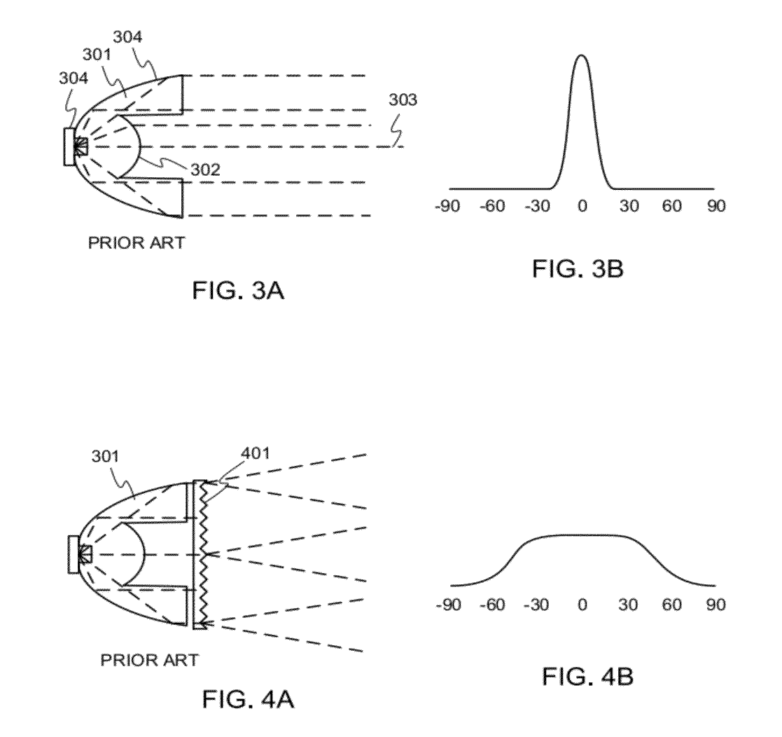

FIG. 3A illustrates a particular type of prior art concentrator 301 that has been used with LEDs, for example LEDs similar to LED 102, to direct the light in the wide pattern generated by the LED into a narrow beam. Concentrator 301 works using a combination of refraction and total internal reflection. Lens element 302 refracts the light emanating at shallow to moderate angles from the axis 303 of the LED 304, parabolic reflective element 305 reflects the light emanating at steeper angles via total internal reflection. The resulting illumination beam may be narrow, as illustrated in FIG. 3B. With careful design, concentrator 301 may be molded as a single low cost clear plastic part. Concentrator 301 may be called a “TIR concentrator”, because the parabolic surface reflects light using total internal reflection.

It will be appreciated that the functioning of TIR concentrator 301 depends on maintaining the precise positional relationship between concentrator 301 and LED 304, and thus TIR concentrator 301 is not easily amenable to adjustment to vary the illumination field. As illustrated in FIG. 4A, a diffusing element 401 may be added to a TIR concentrator to produce a wider illumination field as shown in FIG. 4B. Diffusing element 401 may be frosted, or may have a pattern of small facets that refract the light through the desired angles. However, the resulting illumination field is still fixed, and installing a different diffuser element may be inconvenient in the field.

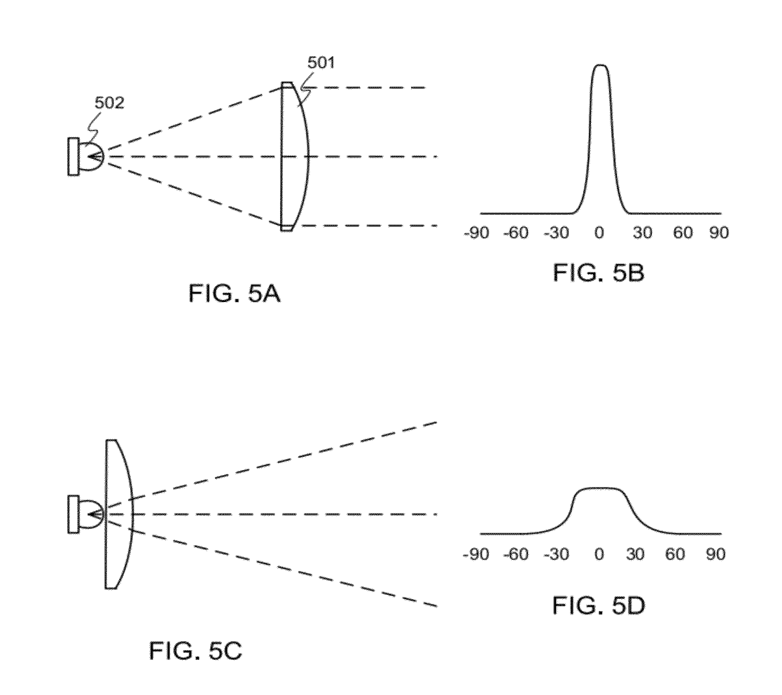

FIGS. 5A-5D illustrate the use of a simple positive refractive lens 501 to vary the illumination field of an LED 502, in accordance with embodiments of the invention. In FIG. 5A, LED 502 is placed at approximately the focal point of the lens, and the light emanating from LED 502 is directed substantially into a narrow beam, for example having the distribution shown in FIG. 5B. In FIG. 5C, lens 501 has been moved toward LED 502 (or LED 502 moved toward lens 501), and the light is defocused into a wider beam, for example having the distribution shown in FIG. 5D. Placing lens 501 and LED 502 in a relationship intermediate between those shown in FIGS. 5A and 5C will result in an illumination distribution intermediate between those shown in FIGS. 5B and 5D. When the lens and LED are closest together, the positive power of the lens affects the beam pattern of the LED the least, although the beam is still somewhat narrower than the light distribution produced by the LED itself. In other words, the lens still has a converging effect, but much less than when the LED is at the approximate focal point of the lens.

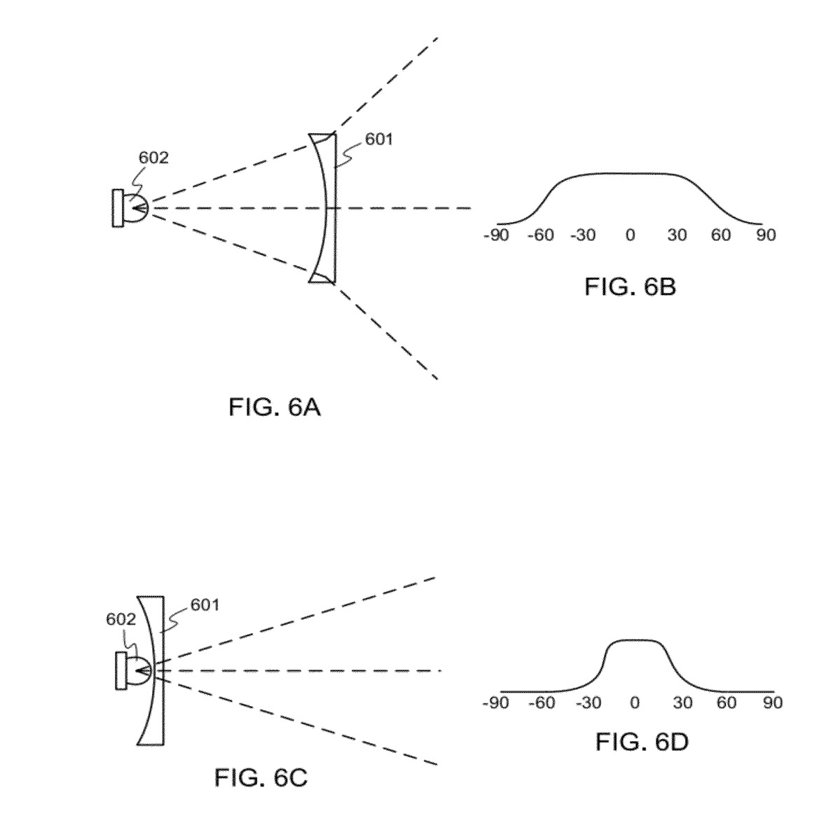

FIGS. 6A-6D illustrate the use of a simple negative refractive lens 601 to vary the illumination field of LED 602, in accordance with embodiments of the invention. When lens 601 is placed further away from LED 602, as shown in FIG. 6A, the beam will be maximally diverged, for example having an angular distribution as shown in FIG. 6B. When lens 601 and LED 602 are closest together, as shown in FIG. 6C, the negative power of lens 601 affects the beam pattern of LED 601 the least, and the beam may have an angular distribution similar to that shown in FIG. 6D. The beam will still be somewhat wider than that produced by the LED itself.

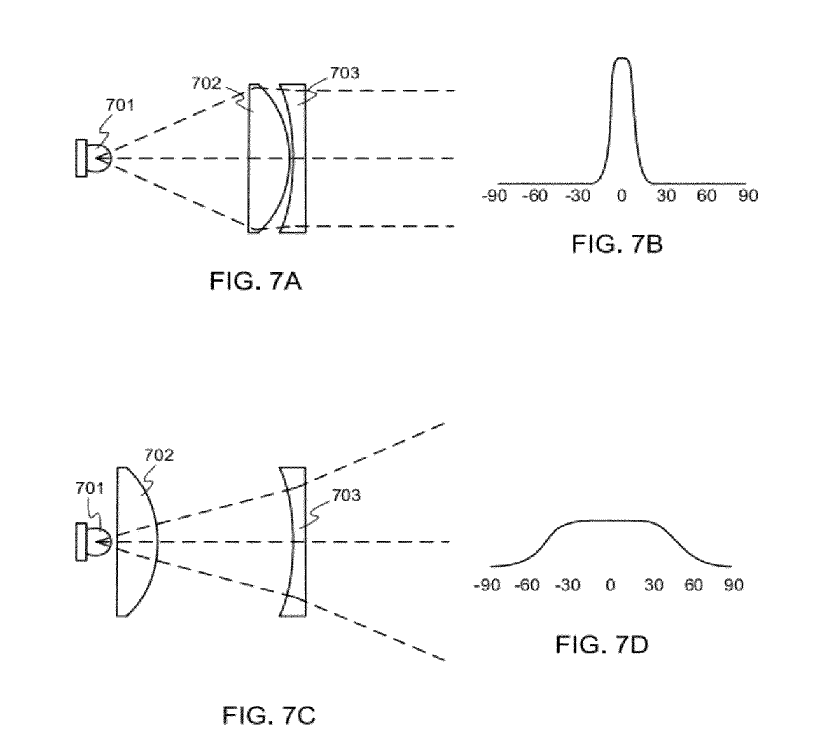

FIGS. 7A-7D illustrate a use of multiple lens elements to vary the illumination field of LED 701, in accordance with embodiments of the invention. The system of FIGS. 7A-7D may result in a broader range of adjustment than is achievable with a single lens. In this example, a relatively strong positive lens element 702 is placed immediately in front of LED 701, and is movable toward and away from LED 701. A relatively weaker negative (concave) lens element 703 is placed at a fixed position beyond positive element 702. When the (strong) positive lens is closest to the (weak) negative element, as shown in FIG. 7A, they can be considered together as a composite element with moderate positive power. As above, if the LED and lenses are positioned such that the LED is at the approximate focal point of the composite element(s), the resulting beam will be maximally focused, for example having an angular distribution similar to that shown in FIG. 7B. If positive element 702 is moved toward LED 701 and away from negative element 703, the beam will be gradually defocused or dispersed. As above, when positive lens element 702 is closest to LED 701 as shown in FIG. 7C, the beam will be maximally defocused, for example having an angular distribution similar to that shown in FIG. 7D. As compared to the case above, the combined use of a fixed negative lens and a moving positive lens provides a greater range of beam angles between narrow (maximally focused) and wide (maximally defocused) angular distributions. The greatest difference in performance may be in the wide angle case. This is because the positive element's converging effect is minimized when it is closest to the LED, while diverging effect of the negative element remains.

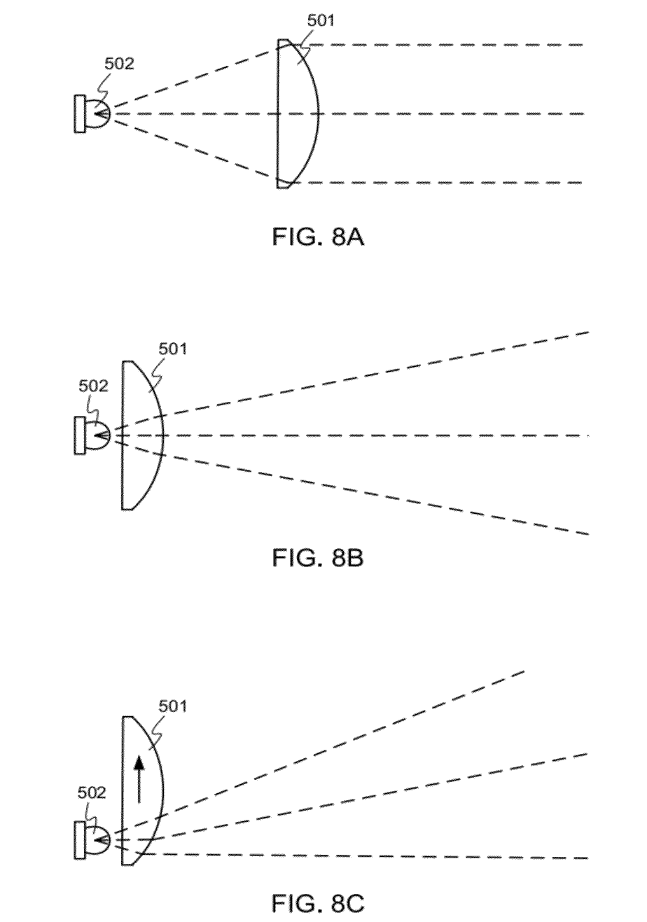

FIGS. 8A-8C illustrate an arrangement similar to that of FIG. 5A, but with an additional degree of freedom that may improve the wide angle performance an illuminator in accordance with embodiments of the invention. In the example configuration of FIG. 8A, LED 502 is positioned approximately at the focal point of lens 501, resulting in a narrow illumination field. In the configuration of FIG. 8B, LED 502 and lens 501 are positioned more closely together, resulting in a somewhat wider illumination field. In FIG. 8C, lens 501 has been additionally moved transversely to the optical axis of LED 502. This causes the diverging beam to be skewed from the optical axis of LED 502. It is useful to think of positive lens 501 when it is directly in front of LED 502, but displaced laterally, as behaving as a wedge prism. The diverging light from LED 502 is refracted laterally as it exits lens 501.

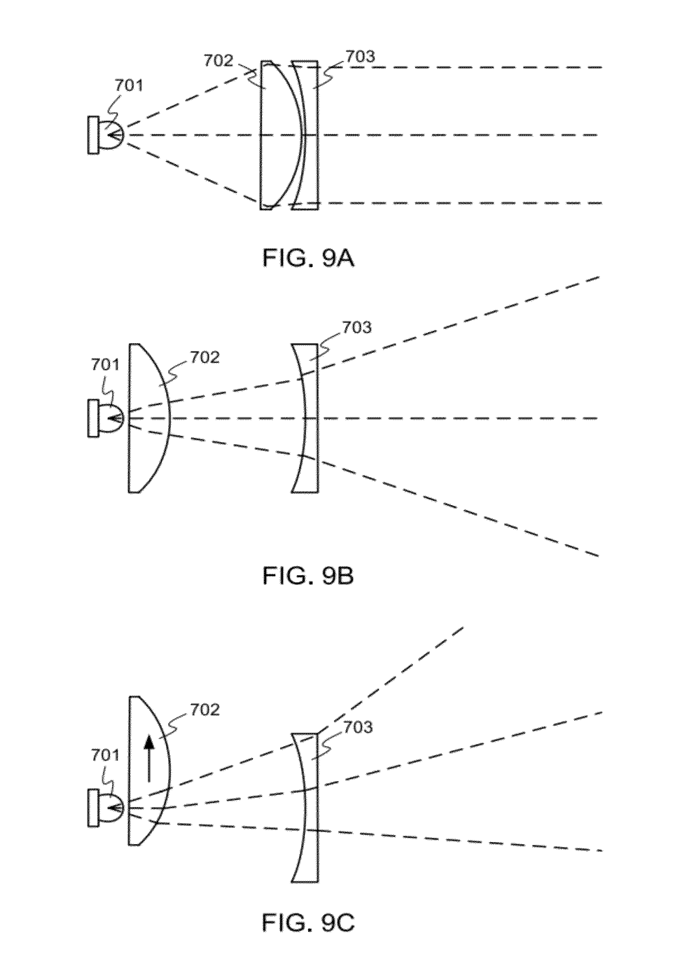

FIGS. 9A-9C illustrate an arrangement similar to that of FIG. 7A, with an additional degree of freedom similar that that shown in FIG. 8C, and that may improve the wide angle performance an illuminator in accordance with embodiments of the invention. In the example configuration of FIG. 9A, LED 701 is positioned approximately at the focal point of the composite lens formed by relatively strong positive element 702 and relatively weak negative element 703, resulting in a narrow illumination field. In the configuration of FIG. 9B, LED 701 and positive element 702 are positioned more closely together while negative element 703 remains in its original position, resulting in a somewhat wider illumination field. In FIG. 9C, positive element 702 has been additionally moved transversely to the optical axis of LED 701, skewing the illumination beam both by the prismatic effect of positive element 702, and further by the prismatic effect of negative element 703.

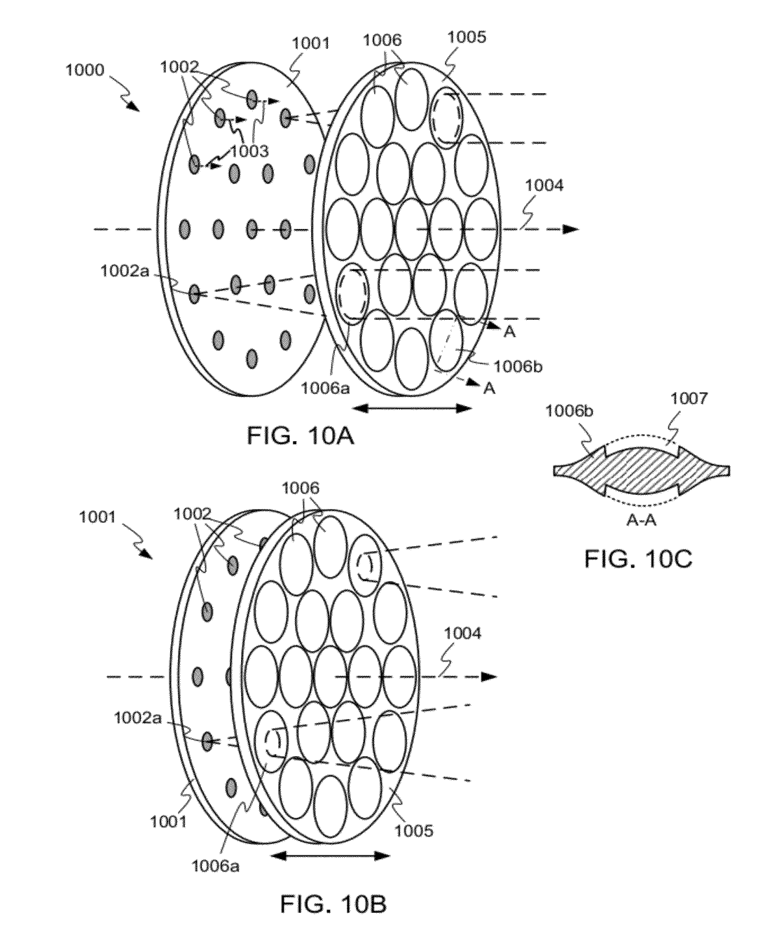

FIGS. 10A and 10B illustrate an illuminator 1000 according to an embodiment of the invention. Example illuminator 1000 operates on a principle similar to that illustrated in FIGS. 5A-5D. In illuminator 1000, an array of LEDs 1002 are mounted to a circuit board 1001. LEDs 1002 may be of any suitable type, for example surface mounted or in packages having leads, and with our without integral lenses. Not all of LEDs 1002 need be of the same type. While an array of 19 LEDs is shown in FIG. 10A, more or fewer LEDs may be used, depending on the particular application the illuminator is intended for, the performance of the LEDs used, and other factors. Illuminator 1000 may also include a power supply, control electronics for driving LEDs 1002, and other elements, but these components are not shown in FIG. 10 so as not to obscure the principles of the invention in unnecessary detail. Circuit board 1001 may also be any suitable type, but may preferably be a metal-core circuit board that effectively cools LEDs 1002.

Each of LEDs 1002 has an optical axis 1003 that defines the principal direction in which the LED emits light, and LEDs 1002 are arranged such that their respective optical axes 1003 are substantially parallel to each other. Illuminator 1000 may also have an optical axis 1004, which may be substantially parallel to the optical axes 1003 of LEDs 1002. LED's 1002 may be dispersed approximately uniformly across circuit board 1001, or may be clustered more densely in some areas.

Illuminator 1000 also includes a lens plate 1005 positioned immediately in front of the array of LEDs 1002. Here, to be positioned immediately in front of the array of LEDs 1002 means that there are no other optical components between the LEDs 1002 and lens plate 1005 that would affect the field of illumination of illuminator 1000. If any of LEDs 1002 include integral lenses, those lenses are considered to be part of the LEDs, and not additional optical components between the LEDs and lens plate 1005.

Example lens plate 1005 is movable in the direction of the optical axis 1004, so that the distance between lens plate 1005 and LEDs 1002 can be varied. Moving lens plate 1005 while holding LEDs 1002 fixed is one way of changing the relative positions of lens plate 1005 and LEDs 1002. In other embodiments, the relative positions of lens plate 1005 and LEDs 1002 could be changed by moving LEDs 1002 while holding lens plate 1005 fixed, or moving both lens plate 1005 and LEDs 1002 in a relative manner.

Lens plate 1005 includes a plurality of lenses 1006. In some embodiments, lens plate 1005 includes exactly one lens 1006 for each of LEDs 1002, but other arrangements are possible. For example, one lens 1006 may correspond to a cluster of closely-spaced LEDs mounted together on circuit board 1001. Lenses 1006 may be positive or negative lenses. In some embodiments, lens plate 1005 is a single molded part, and lenses 1006 are formed by variations in the thickness of lens plate 1005. In other embodiments, lens plate 1005 may be assembled from multiple components, including individual lenses 1006. Lens plate 1005 may be molded or otherwise formed of any suitable material, for example polycarbonate, acrylic, or any other polymer or blend of polymers having appropriate optical properties in the wavelengths of interest.

In the embodiment shown in FIG. 10A, lenses 1006 are positive lenses, and lens plate 1005 is positioned such that each of LEDs 1002 is approximately at the focal point of its corresponding lens 1006. That is, the distance between LEDs 1002 and lens plate 1005 is approximately equal to the focal length of lenses 1006. As is illustrated by particular LED 1002a and particular lens 1006a, each lens 1006 produces a relatively narrow beam from the light produced by its corresponding LED 1002. This configuration is similar that that shown for a single LED and lens in FIG. 5A.

FIG. 10B shows illuminator 1000 in a different configuration, in which lens plate 1005 has been moved closer to LEDs 1002. This arrangement is analogous that shown for a single LED and lens in FIG. 5C. In this configuration, each of lenses 1006 produces a diverging beam, and thus so does illuminator 1000. The size of the field illuminated by LEDs 1002 is varied by the position of lens plate 1005.

FIG. 10C illustrates a cross section or an example individual lens 1006b, in accordance with embodiments. To improve the moldability of lens plate 1005, one or more Fresnel steps 1007 may optionally be included, to reduce the thickness of lens 1006b while still providing a positive lens. Many other lens shapes are possible, and not all of lenses 1006 need be of the same shape.

Although not shown, lens plate 1005 could include an array of negative lenses, and could be operated to adjust the illumination field size in a manner analogous to that shown in FIGS. 6A-6D.

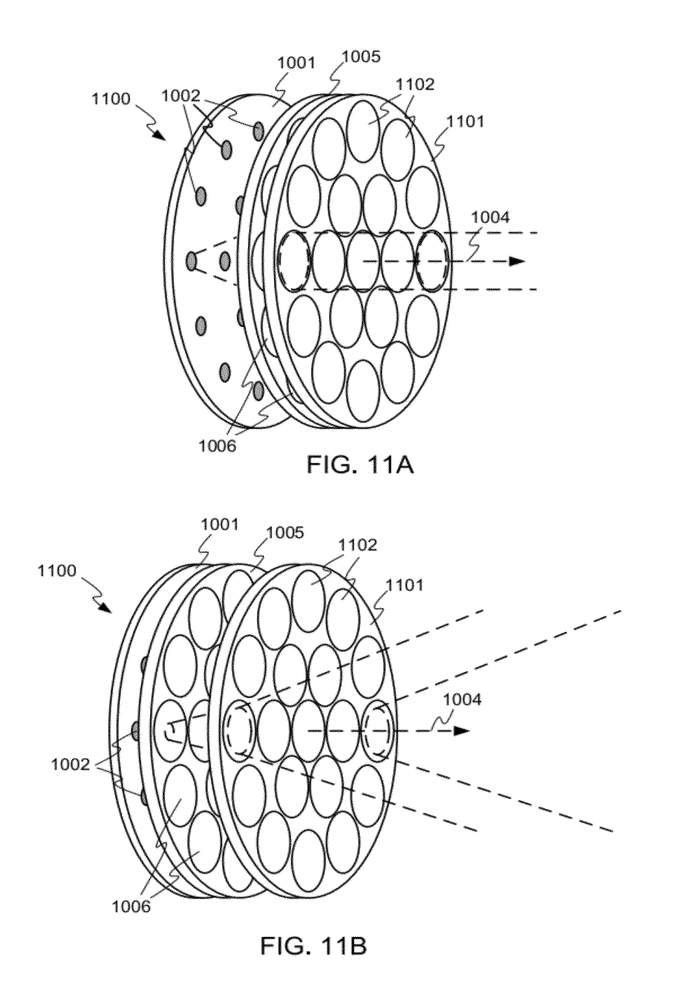

FIGS. 11A and 11B illustrate an illuminator 1100 according to another embodiment of the invention. Example illuminator 1100 operates on a principle similar to that illustrated in FIGS. 7A-7D. Example illuminator 1100 includes a circuit board 1001 and a movable lens plate 1005, similar to those shown in FIGS. 10A and 10B, and also includes a cover plate 1101 in front (further from LEDs 1002) of movable lens plate 1005. Preferably, cover plate 1101 is fixed in position in relation to LEDs 1002, while lens plate 1005 can move in the direction of optical axis 1004. Cover plate 1101 may include a plurality of cover plate lenses 1102, which may be negative lenses. Cover plate 1101 and cover plate lenses 1102 may be integrally formed from a single molded element, or may be assembled from individual components. In FIG. 11A, lens plate 1005 is positioned near cover plate 1101, such that LEDs 1002 are approximately at the focal points of the composite lenses formed by lenses 1006 and 1102. Accordingly, a relatively narrow beam is produced. This arrangement is analogous to that shown for a single composite lens and LED in FIG. 7A.

While the same reference numerals have been used to designate similar elements in the figures, it will be recognized that elements having the same reference numeral need not be strictly identical in all embodiments. For example, each of illuminators 1000 and 1100 includes a lens plate 1005 having lenses 1006, but the curvatures of the surfaces of lenses 1006 need not be identical in the two embodiments. Any of the optical components may be specifically designed for a particular implementation, for example to accommodate particular brands of LEDs, to be compatible with other components of a particular embodiment, or for other reasons.

FIG. 11B shows example illuminator 1100 with lens plate moved closer to LEDs 1002, analogous to the arrangement of FIG. 7C. Accordingly, each lens pair produces a diverging beam, and the combined beams also diverge. The size of the illumination field produced by illuminator 1100 is thus adjustable by adjusting the position of lens plate 1005.

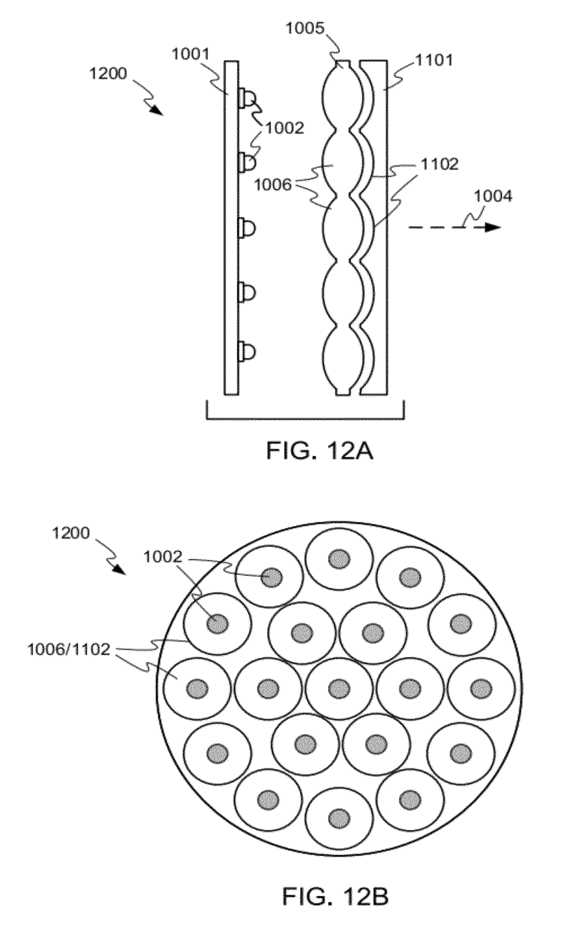

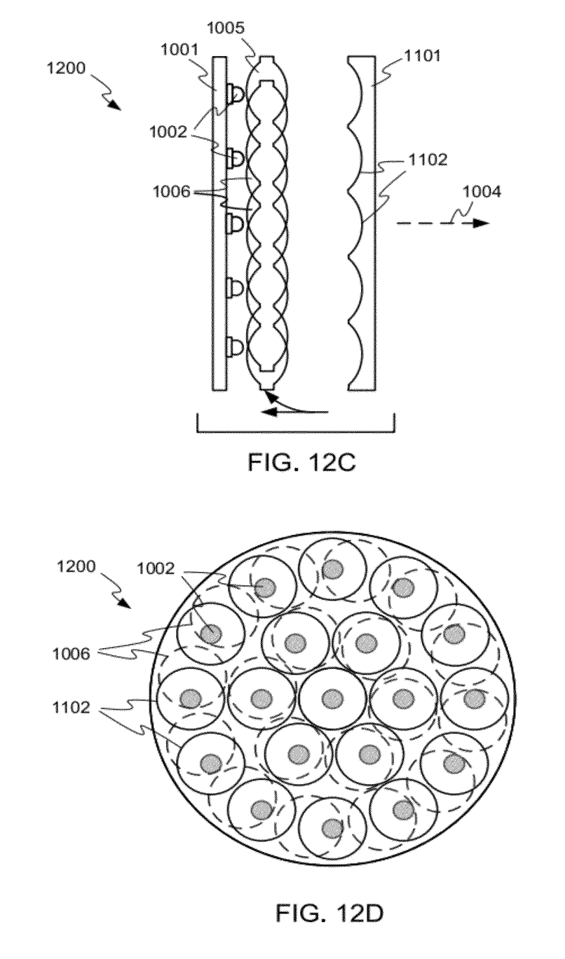

FIGS. 12A-12D illustrate orthogonal views of an illuminator 1200 in accordance with another embodiment. Example illuminator 1200 operates on a principle similar to that illustrated in FIGS. 9A-9C. FIG. 12A is a side view showing circuit board 1001 with an array of LEDs 1002 mounted on it. A lens plate 1005 and cover plate 1101 include lenses 1006 and cover plate lenses 1102, as described above. Illuminator 1200 may have an optical axis 1004. FIG. 12B shows illuminator 1200 as viewed along optical axis 1004, and shows that in this configuration, lenses 1006, cover plate lenses 1102, and LEDs 1002 are aligned.

FIGS. 12C and 12D illustrate illuminator 1200 after lens plate 1005 has been moved closer to LEDs 1002, and also rotated about an axis parallel to axis 1004. As is visible in FIG. 12D, lenses 1006 are no longer aligned with LEDs 1002 and cover plate lenses 1102. The translation and rotation of lens plate 1005 may be independent degrees of freedom such that either may be adjusted independently of the other, or may be tied together so that a particular translational position corresponds to a particular rotational orientation. The rotation of lens plate 1005 while holding LEDs 1002 fixed is one way of changing the rotational alignment of lens plate 1005 and LEDs 1002. In other embodiments, the change in rotational alignment could be accomplished by rotating LEDs 1002 while holding lens plate 1005 fixed, or by moving lens plate 1005 and LEDs 1002 in a relative manner.

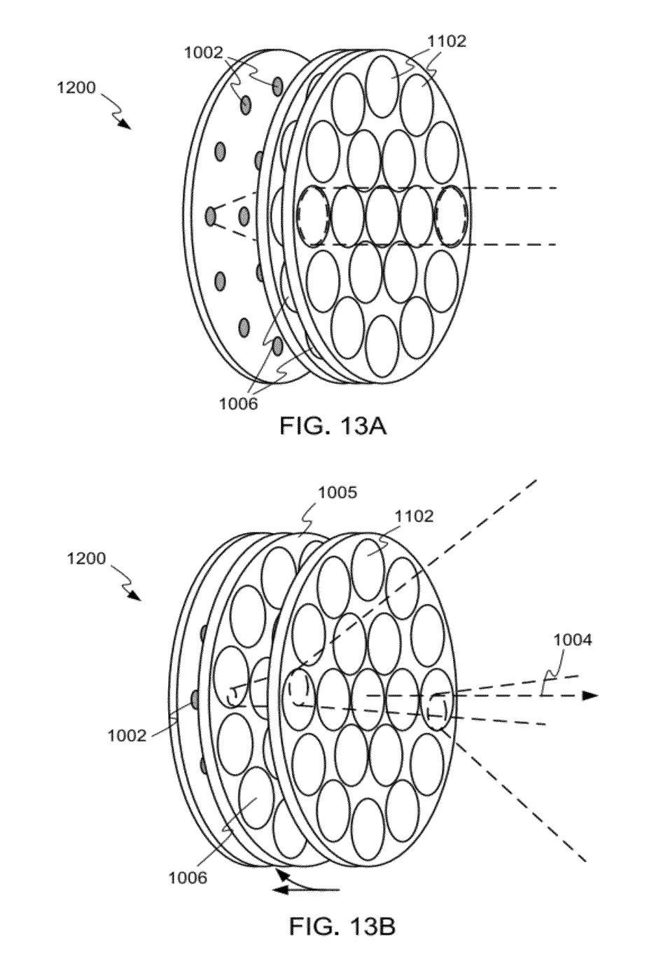

FIGS. 13A and 13B are oblique views of the configurations shown in FIGS. 12A and 12D respectively. As is apparent in FIG. 13A, when LEDs 1002, lenses 1006, and cover plate lenses 1102 are aligned, each LED/lens/cover plate lens combination produces a relatively narrow beam, and therefore so does illuminator 1200. As is visible in FIG. 13B, once lens plate 1005 has been moved toward LEDs 1002 and also rotated, each LED/lens/cover plate lens combination produces a beam that is divergent and also skewed relative to optical axis 1004 of illuminator 1200. Both the divergence and the skew contribute to the broadening of the composite beam produced by illuminator 1200. That is, each beam diverges, and is also “steered” away from the optical axis of illuminator 1200.

In the configuration with a moving positive lens and fixed negative fixed lens, the skewed beam is further skewed by the prismatic effect of the negative lens. Lenses near the center of the array are decentered only a small amount with respect to the LEDs, and so their beam divergence pattern is relatively unaffected. On the other hand, the lenses nearer the outside of the array are decentered significantly from their respective LEDs. This causes their divergence pattern to be skewed off of the optical axis by the prismatic effect of the positive lens array, and then further spread and skewed by the effect of the negative lens array. Since the skewing effect is radially symmetrical about the axis of rotation of the positive lens array plate 1005, the combined effect is a wider total divergence pattern from the illuminator. The combination of the lesser skew of the inner LEDs and the greater skew of the outer LEDs results in a wide illumination pattern without significant voids or “hot spots”.

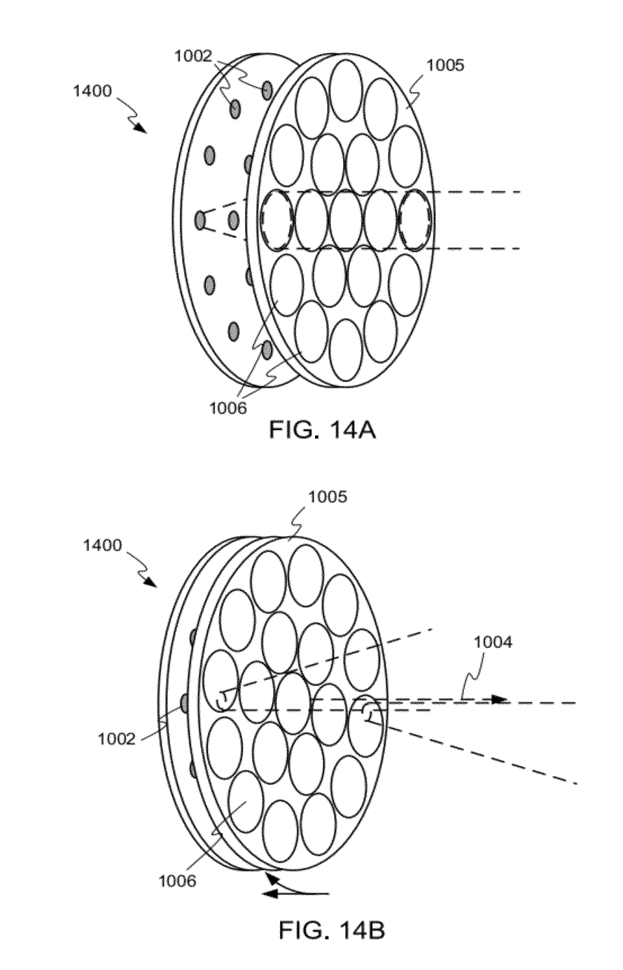

FIGS. 14A and 14B illustrate an illuminator 1400 according to another embodiment of the invention. Example illuminator 1100 operates on a principle similar to that illustrated in FIGS. 8A-8C, and is similar to illuminator 1200, but lacks cover plate 1101. Example illuminator 1400 may be less complex and therefore less expensive to manufacture than illuminator 1200. With careful design of lens plate 1005 and design of the motion of lens plate 1005, illuminator 1400 may perform nearly as well as illuminator 1200.

In FIG. 14A, lens plate 1005 is positioned such that LEDs 1002 are approximately at the focal points of lenses 1006. This position is analogous to that shown in FIG. 8A for a single LED and lens. Accordingly, each LED/lens combination produces a relatively narrow illumination beam, and the combined beam produced by illuminator 1400 is also relatively narrow.

In FIG. 14B, lens plate 1005 has been moved closer to LEDs 1002, and also rotated about axis 1004. This position is analogous to that shown in FIG. 8C for a single LED and lens. As can be seen, the combination of the decreased convergence effect of lenses 1006 and the prismatic effect of lenses 1006 being misaligned with LEDs 1002 causes the beam produced by each LED/lens combination to be divergent and skewed with respect to axis 1004. The divergence of the composite beam produced by illuminator 1400 is adjustable by adjusting the position and rotation of lens plate 1005. As in any of the embodiments shown, the beam is continuously adjustable, although embodiments may be envisioned in which components are positionable only in a limited number of selected positions.

The translation and rotation of lens plate 1005 may be independent degrees of freedom such that either may be adjusted independent of the other, or may be tied together so that a particular translational position corresponds to a particular rotational orientation.

An illuminator according to embodiments may be a varifocal illuminator or a zoom illuminator, and may further include an actuator for moving lens plate 1005. In a varifocal illuminator, any movable components may be set to a particular configuration at installation time, for example to match a particular area to be monitored or to match the field of view of a particular camera having a fixed field of view. Once the correct position is determined, the components may be locked in place. For example, access may be provided to an actuator mechanism including a leadscrew, lever, gears, bearings, or other components for holding and moving lens plate 1006. Locking may be accomplished with a setscrew, clamp, adhesive, or any other suitable mechanism, for example by the inherent friction or static retaining force of the actuator mechanism.

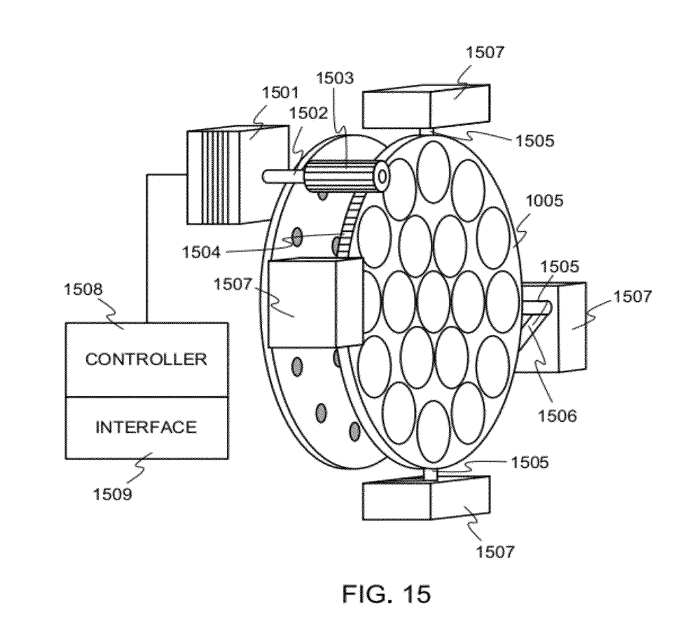

In a zoom illuminator, the position of one or more movable components may be adjustable during operation, for example to continuously match the field of view of a camera having a zoom lens. FIG. 15 illustrates one example actuator usable in embodiments of the invention. In this embodiment, a motor 1501 has a shaft 1502 on which a pinion gear 1503 is mounted. Lens plate 1005 also has gear teeth 1504 molded into its peripheral edge, and pinion gear 1503 engages with gear teeth 1504 such that when motor 1501 turns pinion gear 1503, lens plate 1005 also rotates. A number of guide pins 1505 (only three of which are visible in FIG. 15) protrude radially from lens plate 1005, and engage angled grooves 1506 (only two of which are visible in FIG. 15). For example, angled grooves 1506 may be formed in features 1507 within a housing (not shown) that encloses the elements shown in FIG. 15. As lens plate 1005 rotates, guide pins 1505 track in angled grooves 1506 and cause lens plate to also move toward or away from LEDs 1002. This is an example of a mechanism in which translation and rotation of lens plate 1005 are tied together. Motor 1501 may be controlled and driven by a controller 1508. Motor 1501 may be a stepper motor, DC motor, AC motor, a solenoid and ratchet, or any other suitable kind of motor. Additional gearing may be present, for example for increasing the torque applied to lens plate 1005 and for providing a holding force to retain lens plate in a particular position when motor 1501 is not energized. Many other kinds of actuators may be utilized in embodiments.

Controller 1508 may be microprocessor-based, and may be specially programmed or otherwise configured to control various functions of an illuminator according to embodiments. For example, controller 1508 may include a communications interface 1509, for receiving commands and returning status information to a remote control center, as is described in more detail below.

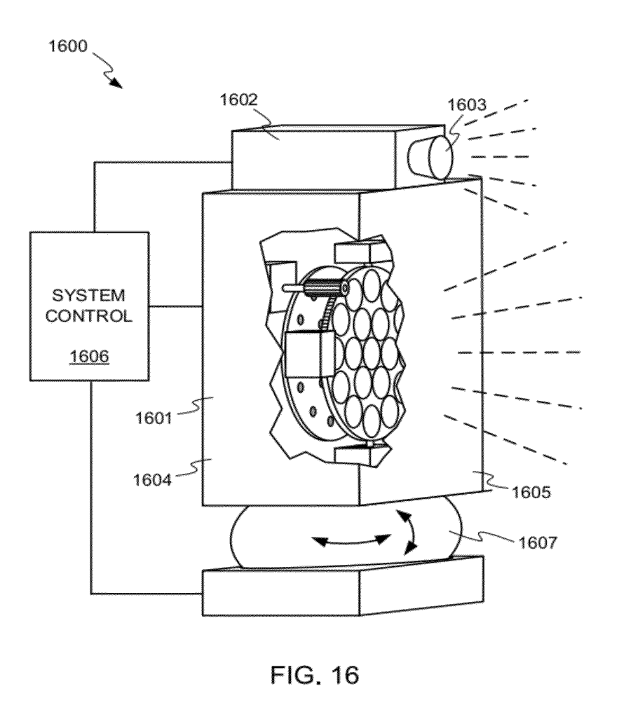

FIG. 16 illustrates a system 1600 in accordance with another embodiment of the invention. In system 1600, a variable focus illuminator 1601 is used in conjunction with a camera 1602. In some embodiments, camera 1602 may have a fixed field of view, and variable focus illuminator may be a varifocal illuminator set to produce a fixed illumination field compatible with the field of view of camera 1602. However, in other embodiments such as the embodiment shown in FIG. 16, camera 1602 comprises a zoom lens 1603 such that the field of view of camera 1602 can be varied. In that case, variable focus illuminator 1601 preferably also includes a zoom capability with an automatic actuator such as the actuator of FIG. 15 as shown.

Variable focus illuminator 1601 may be enclosed in a housing 1604 having a front face 1605 that is substantially transparent to light from LEDs 1002. When infrared LEDs 1002 are used, front face 1605 need not be transparent to visible light, so that the inner workings of variable focus illuminator may be hidden from view. If an illuminator having a cover plate with cover plate lenses is used, for example illuminator 1100, front face 1605 may conveniently serve as the cover plate, and may have the cover plate lenses integrally molded into it. In some embodiments, camera 1602 may also be enclosed by housing 1604.

A system controller 1606 may be used to control variable focus illuminator 1601. System controller 1606 may be, for example, located at a remote monitoring center where an operator or computer can direct the settings of variable focus illuminator 1601, such as the on/off state or power level of the LEDs, the angle of illumination, or other settings. System controller 1606 may both send commands and also receive information back from illuminator 1601. Information received from the illuminator can include ambient light level, power supply voltage or current, or internal or external temperatures, for example. System controller 1606 may communicate with variable focus illuminator 1601 and camera 1602 by any suitable interface, for example, Ethernet, USB, Firewire, RS-232, RS-422, or any other standard or proprietary interface or interfaces

System controller 1606 may also control both camera 1602 and variable focus illuminator 1601 such that they work compatibly together. System controller 1606 may be, for example, located at a remote monitoring center where an operator can direct the motions and zoom settings of variable focus illuminator 1601 and camera 1602, either separately or together. System controller 1606 may send commands and also receive information back from camera 1602, for example the image of video data produced by camera 1602, diagnostic information about variable focus illuminator 1601 or camera 1602, or other information. Many different arrangements are possible.

Both variable focus illuminator 1601 and camera 1602 may be mounted on a pan/tilt mechanism 1607, which may also be controlled by system controller 1606.

The control mechanism for variable focus illuminator 1601 may be logically or physically separate from the camera control mechanism. It could also advantageously be integrated with the camera control. For example, an operator may have a single control lever or software slider which simultaneously modifies the camera zoom setting along with the illuminator's angle of coverage. As another example, a computer program may automatically point and zoom the camera at a target of interest, while simultaneously zooming the illuminator. In some embodiments, the illuminator control signals could also be “piggy-backed” on the camera's video interface, as is sometimes done with PTZ control signals.

In addition to providing control signals remotely from an operator or control computer, it is possible for the illuminator to receive its control signals directly from the camera or pan/tilt controller. When the camera is instructed to change its zoom lens setting, the camera or PTZ controller could instruct the illuminator to change its angle of illumination. The control information could be transmitted from the camera or PTZ to the illuminator via any of the means described above. It is also possible for the illuminator to detect (“eavesdrop” on) the control signals being sent to the camera. In other words, when an operator or control computer sends a signal to the camera to change its lens setting, the illuminator could listen and respond to the camera control message by changing its angle of illumination to match. This has the advantage that no additional control hardware, software, or wiring infrastructure is required to support the zoom capability of the illuminator. In other words, the illuminator could be added to the zoom camera installation with minimal integration effort.

Having an interface to the zoom illuminator, either connected back to a monitoring center or connected to the camera or PTZ controller, allows other status monitoring and control functions in addition to controlling the illumination angle. For example, the interface could be used to remotely control when the illuminator is on or off, or to control the power level of its output. It can be used to remotely monitor characteristics of the illuminator and its environment, such as its input voltage, current, power level, temperature, output light level, ambient light level. It could also be used to remotely monitor the “health” of its internal components. It may be quite beneficial to remotely run diagnostics, or to sense a failure or potential for failure of the illuminator.

In some embodiments, illuminator 1601 may have stored within it a number of “presets”. These are combinations of settings, such as field of illumination and light power level, which can be recalled by issuing single commands from the system controller 1606. For example, illuminator may include a controller similar to controller 1508, including a communications interface 1509 for communicating with system control 1606, and configured to control various aspects of the operation of illuminator 1601. System control 1606 may send a single command instruction illuminator 1601 to recall one of the presets, and controller 1508 may then adjust illuminator 1601 to conform to the preset. While presets stored in illuminator 1601 may be addressed independently, it is particularly advantageous for the illuminator presets to match specific camera and/or pan/tilt presets, such that issuing the preset commands for a pan/tilt position, a camera zoom setting, and an illuminator angle and power setting are all well-matched. As described above, it is possible for the illuminator to detect (eavesdrop on) preset commands being sent to camera 1602 and/or pan/tilt/zoom mechanism 1607. Thus a single command may invoke the desired settings for camera, pan/tilt mechanism, and illuminator. As described above, this has the advantage that no additional control hardware, software, or wiring infrastructure is required to support the zoom capability of the illuminator.

While the Figures and description above disclose certain embodiments having certain combinations of features, any of the disclosed features may be utilized in any workable combination. For example, the actuator depicted in FIG. 15 may be utilized to move the movable lens plate of the embodiment of FIGS. 13A and 13B. In another example, the system of FIG. 16 shows an optical system similar to that of FIGS. 14A and 14B, driven by the actuator of FIG. 15, but any of the illuminators described herein may be used in such a system. It is to be understood that any workable combination of the features and elements disclosed herein is also considered to be disclosed.

The invention has now been described in detail for the purposes of clarity and understanding. However, those skilled in the art will appreciate that certain changes and modifications may be practiced within the scope of the appended claims.

What is claimed is:

1. A variable focus illuminator, comprising:
a plurality of light sources arranged in an array; and
a lens plate positioned immediately in front of the array of light sources, the lens plate comprising a plurality of lenses that redirect the light produced by the light sources;
wherein the relative positions of the lens plate and the light sources are changeable such that different relative positions of the lens plate and light sources result in different sizes of the field illuminated by the light sources.

2. The variable focus illuminator of claim 1, wherein the lens plate is movable to change the distance between the lens plate and the light sources.

3. The variable focus illuminator of claim 1, wherein the lens plate is rotatable about a rotation axis that is substantially parallel to the optical axis of the variable focus illuminator.

4. The variable focus illuminator of claim 3, wherein rotation of the lens plate causes beams emanating from at least some of the lenses to be skewed with respect to an optical axis of the variable focus illuminator.

5. The variable focus illuminator of claim 1, further comprising a locking mechanism to fix the lens plate in a particular position in relation to the light sources.

6. The variable focus illuminator of claim 1, further comprising an actuator configured to move the lens plate.

7. The variable focus illuminator of claim 6, wherein the actuator comprises a motor coupled to the lens plate, and wherein the lens plate moves in reaction to rotation of a shaft of the motor.

8. The variable focus illuminator of claim 6, where the actuator is configured to change the distance between the lens plate and the light sources.

9. The variable focus illuminator of claim 6, wherein the actuator is configured to rotate the lens plate about a rotation axis substantially parallel to the optical axis of the variable focus illuminator.

10. The variable focus illuminator of claim 9, wherein the actuator is configured to simultaneously vary the rotational angle of the lens plate and the distance between the lens plate and the light sources.

11. The variable focus illuminator of claim 10, wherein the actuator further comprises:
a plurality of guide pins protruding radially from the lens plate; and
a plurality of angled grooves in which the pins ride to tie the rotational angle of the lens plate to the distance between the lens plate and the light sources.

12. The variable focus illuminator of claim 11, further comprising:
a motor having a shaft;
a gear driven by the motor; and
gear teeth molded into a peripheral edge of the lens plate and configured to mate with the teeth of the gear, such that the lens plate is moved by rotation of the motor shaft.

13. The variable focus illuminator of claim 1, wherein the lens plate is a monolithic structure, with the plurality of lenses being formed by variations in the thickness of the monolithic structure.

14. The variable focus illuminator of claim 1, wherein each of the plurality of lenses is a positive lens.

15. The variable focus illuminator of claim 1, wherein each of the plurality of lenses is a negative lens.

16. The variable focus illuminator of claim 1, further comprising a cover plate in front of the movable lens plate and fixed in relation to the light sources.

17. The variable focus illuminator of claim 16, wherein the cover plate further comprises a plurality of cover plate lenses, and wherein the cover plate lenses are formed by variations in the thickness of the cover plate.

18. The variable focus illuminator of claim 17, further comprising an enclosure, wherein the cover plate forms a front face of the enclosure.

19. The variable focus illuminator of claim 17, wherein each of the lens plate lenses is a positive lens, and each of the cover plate lenses is a negative lens.

20. The variable focus illuminator of claim 17, wherein the cover plate includes exactly one cover plate lens for each of the light sources.

21. The variable focus illuminator of claim 1, wherein the plurality of light sources comprises one or more light emitting diodes.

22. The variable focus illuminator of claim 1, wherein the light sources emit infrared light.

23. The variable focus illuminator of claim 1, wherein the light sources emit visible light.

24. The variable focus illuminator of claim 1, further comprising a printed circuit board on which the plurality of light sources are mounted.

25. The variable focus illuminator of claim 1, wherein the lens plate includes exactly one lens for each light source.

26. The variable focus illuminator of claim 1, further comprising a controller configured to control the position of the lens plate to vary the size of the field illuminated by the light sources.

27. The variable focus illuminator of claim 26, wherein the controller comprises a communication interface through which control commands are received from a remote control center.

28. The variable focus illuminator of claim 27, wherein the controller is configured to return status information about the variable focus illuminator to the remote control center via the communication interface.

29. The variable focus illuminator of claim 27, wherein the controller stores one or more preset combinations of settings for the variable focus illuminator, each preset combination being recalled in response to a single control command.

30. The variable focus illuminator of claim 27, wherein the controller is configured to change the amount of power being delivered to the light sources in response to a control command received via the communication interface.

31. The variable focus illuminator of claim 27, wherein the controller is configured to change the size of the field illuminated by the light sources in response to a control command received via the communication interface.

32. The variable focus illuminator of claim 27, wherein the controller is configured to change both the amount of power being delivered to the light sources and the size of the field illuminated by the light sources in response to a single control command received via the communication interface.

33. A system, comprising:
a camera; and
a variable focus illuminator, wherein the variable focus illuminator further includes:
a plurality of light sources arranged in an array; and
a lens plate positioned immediately in front of the array of light sources, the lens plate comprising a plurality of lenses that redirect the light produced by the light sources;
wherein the relative positions of the lens plate and the light sources are changeable such that different relative positions of the lens plate and light sources result in different sizes of the field illuminated by the light sources.

34. The system of claim 33, wherein:
the camera includes a zoom lens; and
the variable focus illuminator includes a motorized actuator configured to change the relative positions of the lens plate and the light sources to adjust the size of the field illuminated by the variable focus illuminator.

35. The system of claim 34, further comprising a communications interface through which control information is received.

36. The system of claim 35, further comprising a controller that automatically adjusts relative positions of the lens plate and the light sources of the variable focus illuminator such that the size of the field illuminated by the variable focus illuminator is increased when the camera field of view increases in size, and the size of the field illuminated by the variable focus illuminator is decreased when the camera field of view decreases in size.

37. The system of claim 36, wherein the controller receives signals via a communications interface, the signals indicating a zoom setting for the camera, and wherein the controller derives a zoom setting for the variable focus illuminator from the camera zoom setting.

38. The system of claim 37, wherein the controller derives the camera zoom setting by detecting control signals directed to the camera.

39. The system of claim 34 further comprising a pan/tilt mechanism to which both the camera and the variable focus illuminator are attached.

40. The system of claim 39, further comprising a controller configured to automatically point and zoom the camera at a target of interest, and to change the size of the field illuminated by the variable focus illuminator to substantially match the field of view of the camera at the selected zoom setting.

41. The system of claim 34, wherein the actuator is configured to move the lens plate.

42. The system of claim 34, further comprising:
a communications interface for exchanging information with a remote monitoring center; and
a controller;
wherein the controller is configured to send status information about the variable focus illuminator to the remote monitoring center via the communications interface.

43. The system of claim 33, further comprising a controller configured to adjust a level of power provided to the light sources.

44. A method of adjusting an illumination field emitted by a variable focus illuminator, the method comprising:
emitting light from a plurality of light sources arranged in an array; and
changing the relative positions of the array of light sources and a lens plate disposed immediately in front of the array of light sources, wherein the lens plate includes a plurality of lenses configured to redirect light received from the plurality of light sources, and wherein the size of the field illuminated by the light sources varies as a result of the change in the relative positions of the array of light sources and the lens plate.

45. The method of claim 44, wherein changing the relative positions of the array of light sources and the lens plate comprises moving the lens plate.

46. The method of claim 44, wherein changing the relative positions of the array of light sources and the lens plate comprises changing the distance between the lens plate and the plurality of light sources.

47. The method of claim 44, wherein changing the relative positions of the array of light sources and the lens plate comprises changing a rotational alignment of the lens plate and the array of light sources with respect to an optical axis of the variable focus illuminator.

48. The method of claim 47, wherein changing the rotational alignment of the lens plate and the array of light sources with respect to the optical axis of the variable focus illuminator causes beams emanating from at least some of the lenses to be skewed with respect to the optical axis of the variable focus illuminator.

49. The method of claim 44, wherein changing the relative positions of the array of light sources and the lens plate comprises both changing the distance between the lens plate and the plurality of light sources and changing a rotational alignment of the lens plate and the array of light sources with respect to an optical axis of the variable focus illuminator.

50. The method of claim 44, further comprising disposing a fixed cover plate in front of the movable lens plate, the fixed cover plate being in a fixed position in relation to the plurality of light sources.

51. The method of claim 44, further comprising, after moving the lens plate to alter the size of the field illuminated by the light sources, fixing the lens plate in place in relation to the light sources.

52. A lens plate, comprising:
a plurality of lenses arranged in an array across the lens plate; and
gear teeth formed in a peripheral edge of the lens plate.

53. The lens plate of claim 52, wherein the lens plate is monolithic and the plurality of lenses are formed by variations in the thickness of the lens plate.

54. The lens plate of claim 53, wherein at least one of the lenses in the lens plate comprises a Fresnel step.

55. A variable focus illuminator, comprising:
at least one light source;
an optical system that is adjustable to change the size of the field illuminated by the at least one light source;
a controller; and
a communication interface through which the controller receives control commands from a remote control center;
wherein the controller is configured to control the operation of the variable focus illuminator in response to control commands received via the communication interface.

56. The variable focus illuminator of claim 55, wherein the controller is configured to adjust the optical system to change the size of the field illuminated by the at least one light source in response to a control command received via the communications interface.

57. The variable focus illuminator of claim 55, wherein the controller is further configured to adjust the amount of power delivered to the at least one light source in response to a control command received via the communication interface.

58. The variable focus illuminator of claim 55, wherein the controller stores at least one preset combination of settings for the variable focus illuminator, and wherein the controller is configured to recall one of the preset combinations in response to a control command received via the communication interface and to adjust the variable focus illuminator to conform to the recalled preset combination of settings.

59. The variable focus illuminator of claim 55, wherein:
the variable focus illuminator comprises a plurality of light sources arranged in an array;
the optical system comprises a lens plate positioned immediately in front of the array of light sources, the lens plate comprising a plurality of lenses that redirect the light produced by the light sources; and
the relative positions of the lens plate and the light sources are changeable such that different relative positions of the lens plate and light sources result in different sizes of the field illuminated by the light sources.

60. The variable focus illuminator of claim 55, wherein the controller is configured to receive at least one control command from the remote control center by detecting a control command directed to a device other than the variable focus illuminator.

61. The variable focus illuminator of claim 55, wherein the controller is configured to provide status information about the variable focus illuminator to the remote control center via the communication interface.
